(19) United States
(12) Patent Application Publication
(10) Pub. No.: US 2026/0177028 A1
(43) Pub. Date: Jun. 25, 2026

(54) Floating Ball Power Generation System

(71) Applicant: Ming-Hui Hsieh, Kaohsiung (TW)

(72) Inventor: Ming-Hui Hsieh, Kaohsiung (TW)

(21) Appl. No.: 19/000,737

(22) Filed: Dec. 24, 2024

(51) Int. Cl. F03B 17/02

(52) U.S. Cl. CPC F03B 17/02

(57) ABSTRACT

The present invention provides a floating ball power generation system, which includes a water collection unit, a ball collection unit, a ball transport unit, a water replenishment unit, a rotary wheel power generation unit, and a ball distribution unit. The ball collection unit is connected to the water collection unit, the ball transport unit is connected to the ball collection unit, the water replenishment unit is connected to the ball transport unit, the rotary wheel power generation unit is connected to the ball transport unit, and the ball distribution unit is connected to the rotary wheel power generation unit and assign the floating ball to the ball collection unit. In this way, the use of pipeline pumping water repeatedly transports the floating ball to drive the rotation of the rotating wheels and the transmission of the rotating shafts, so that the generators can continue to generate electricity day and night.

### BACKGROUND OF THE PRESENT INVENTION

### Field of Invention

The present invention relates to a floating ball power generation system, in particular to a floating ball power generation system that utilizes pipeline pumping to repeatedly transport the floating ball to drive the rotation of the rotating wheels and the transmission of the rotating shafts, so that the generators can continue to generate electricity day and night, without being limited by weather factors and specific areas, and will not cause great pollution to the air and the environment, and do not have to import the coal or natural gas needed for power generation through the foreign countries, so as to achieve the floating ball circulation drive, to provide a very sufficient amount of power generation.

### Description of Related Arts

In general, power generation systems mainly utilize solar energy, wind power, hydropower, coal, or natural gas for electricity generation. Among these, solar power generation is more suitable for areas with ample sunlight, wind power generation is more suitable for areas with sufficient wind, and hydropower generation is more suitable for areas with abundant seawater, reservoirs, or river flow. However, these methods are limited by weather factors such as sunlight, wind, and water flow, as well as specific regional conditions. On the other hand, the use of coal or natural gas for power generation requires the importation of coal or natural gas for power generation, which causes significant air and environmental pollution during the power generation process. If the supply of coal or natural gas needed for power generation is restricted or cannot be imported from abroad, there may be a risk of insufficient power generation.

### SUMMARY OF THE PRESENT INVENTION

The main purpose of the present invention is to provide a floating ball power generation system that utilizes pipeline pumping to repeatedly transport the floating ball to drive the rotation of the rotating wheels and the transmission of the rotating shafts, so that the generators can continue to generate electricity day and night, without being limited by weather factors and specific areas, and will not cause great pollution to the air and the environment, and do not have to import the coal or natural gas needed for power generation through the foreign countries, so as to achieve the floating ball circulation drive, to provide a very sufficient amount of power generation.

The floating ball power generation system of the present invention includes a water collection unit, a ball collection unit, a ball transport unit, a water replenishment unit, a rotary wheel power generation unit, and a ball distribution unit, wherein the water collection unit has a water pumping pipe arranged thereon, a motor connected with the water pumping pipe, a water collecting pipe connected with the motor, a plurality of water inlet pipes connected with the water collecting pipe, and a water inlet valve installed on each the water inlet pipe; wherein the ball collection unit is connected with the water collection unit, wherein the ball collection unit has a plurality of ball collecting pipes connected with the water inlet pipes, a water outlet pipe connected with each of the ball collecting pipes, a water outlet valve provided on the water outlet pipe, a ball entry hole and a ball gate controller provided above the ball collecting pipes, a ball entry gate provided at the ball entry hole, a ball gate pull rod connected with the ball entry gate, a lower tee pipe connected with each of the ball collecting pipes, a sluice controller provided above the lower tee pipe, a sluice gate provided by the lower tee pipe penetration, a sluice pull rod connected with the sluice gate, a discharge pipe provided on the wall of the lower tee pipe, and a discharge valve provided in the discharge pipe, wherein the ball gate controller controls the ball gate pull rod to open or close the ball entry gate; wherein the ball transport unit is connected with the ball collection unit, wherein the ball transport unit has an upper tee pipe connected with the lower tee pipe, a ball transport pipe connected with the upper tee pipe, a guide bend corner and a floating ball channel provided at the top of the ball transport pipe, a floating baffle provided in the floating ball channel, and a first elastic element provided on the floating baffle and fixed to the floating ball channel; wherein the water replenishment unit is connected with the ball transport unit, wherein the water replenishment unit has a water replenishment pipe connected with the ball transport pipe, a water tank connected with the water replenishment pipe, and a water supply pipe and a floating switch provided in the water tank; wherein the rotary wheel power generation unit is connected with the ball transport unit, wherein the rotary wheel power generation unit has a plurality of rotating wheels and a plurality of generators arranged thereon, a rotating shaft provided on each of the generators and connected with each of the rotating wheels, a plurality of floating ball holes evenly provided through the entire circle of each of the rotating wheels and corresponded with the floating ball channel when rotating, a protrusion provided on the inside of each of the rotating wheels adjacent to each of the floating ball holes, a positioning baffle provided on each of the rotating wheels, an oblique baffle provided on each of the rotating wheels and on the opposite side of the positioning baffle, a ball transfer channel provided between each of the rotating wheels and corresponds with the floating ball hole, a ball transfer blocker provided in the ball transfer channel, a second elastic element provided on the ball transfer blocker and fixed on the ball transfer channel, and a power cord connected with each of the generators; wherein the ball distribution unit is connected to the rotary wheel power generation unit, wherein the ball distribution unit has a ball distribution tube, a main ball distribution channel and two allocation ball channels respectively arranged thereon, wherein the ball distribution tube corresponds with the floating ball hole of the rotating wheel, and the main ball distribution channel corresponds with the ball distribution tube, and distributes the floating ball to the allocation ball channels, wherein the allocation ball channels distribute the floating ball to the ball entry holes of the ball collecting pipes.

In the floating ball power generation system of the present invention, the ball collection unit has the plurality of ball collecting pipes connected with the plurality of lower tee pipes, wherein the ball collecting pipes are in an inclined shape, and the ball collecting pipes are allowed to be configured as the first to fourthly channels respectively, wherein the plurality of lower tee pipes are connected with the plurality of upper tee pipes, and the ball transport pipe is connected with the plurality of upper tee pipes.

In the floating ball power generation system of the present invention, the bottom through hole of the lower tee pipe is in a closed state, and the flow channel of the lower tee pipe is a Y-shaped hole.

In the floating ball power generation system of the present invention, the bottom through hole of the upper tee pipe connected to the ball transport pipe is in a closed state, and the flow channel of the upper tee pipe is a Y-shaped hole.

In the floating ball power generation system of the present invention, the water tank is arranged above the platform.

In the floating ball power generation system of the present invention, the plurality of rotating wheels and the plurality of generators are allowed to be configured as the first group to the fourthly group respectively, wherein the ball transfer channel between each of the rotating wheels is fixed with the support column.

In the floating ball power generation system of the present invention, the generators are installed on a bracket, the bracket is fixed with a support column, and the bracket has a support rod arranged thereon and connected with the positioning baffle and the bevel baffle.

In the floating ball power generation system of the present invention, the main ball distribution channel has a first swing element disposed at one end thereof, a first ball distribution gate and a first gate controller disposed at the other end thereof, and a first roller and a first track provided at the bottom of the main ball distribution channel.

In the floating ball power generation system of the present invention, each of the two allocation ball channels has a second swing element disposed at one end thereof, a second ball distribution gate and a second gate controller disposed at the other end thereof, and a second roller and a second track provided at the bottom of each of the allocation ball channels.

In the floating ball power generation system of the present invention, the positioning baffle is arranged on the inside of each of the rotating wheels of first few groups, the oblique baffle is arranged on the outside of each of the rotating wheels of first few groups, and the oblique baffle is arranged on the inside of the rotating wheel of the last group, the positioning baffle is arranged on the outside of the rotating wheel of the last group.

The advantage of the floating ball power generation system of the present invention is that it uses pipelines to pump water and repeatedly transport the floating ball to drive the rotation of the rotating wheels and the transmission of the rotating shafts, so that the generators can continue to generate electricity day and night, without being limited by weather factors and specific areas, and will not cause great pollution to the air and the environment, and do not have to import the coal or natural gas needed for power generation through the foreign countries, so as to achieve the floating ball circulation drive, to provide a very sufficient amount of power generation.

### BRIEF DESCRIPTION OF THE DRAWINGS

FIG. 1 is a perspective view (1) of the overall system framework according to an embodiment of the present invention.

FIG. 2 is a perspective view (2) of the overall system framework according to the embodiment of the present invention.

FIG. 3 is a perspective view (3) of the overall system framework according to the embodiment of the present invention.

FIG. 4 is a perspective view of the floating ball of the water collection unit and the ball collection unit according to the embodiment of the present invention.

FIG. 5 is a perspective view of the floating ball of the ball transport unit and the water replenishment unit according to the embodiment of the present invention.

FIG. 6 is a perspective view of the ball transport pipe guiding the floating ball to the floating ball channel and the floating baffle according to the embodiment of the present invention.

FIG. 7 is a perspective view (1) of the floating ball of the ball transport unit and the rotary wheel power generation unit according to the embodiment of the present invention.

FIG. 8 is a perspective view (2) of the floating ball of the ball transport unit and the rotary wheel power generation unit according to the embodiment of the present invention.

FIG. 9 is a perspective view of the floating ball of the ball distribution unit and the ball collection unit according to the embodiment of the present invention.

### DETAILED DESCRIPTION OF THE PREFERRED EMBODIMENT

In order to achieve the above-mentioned objects and effects of the present invention, the technical means adopted are hereby enumerated through a preferred feasible embodiment, and illustrated in the drawings, detailed as follows:

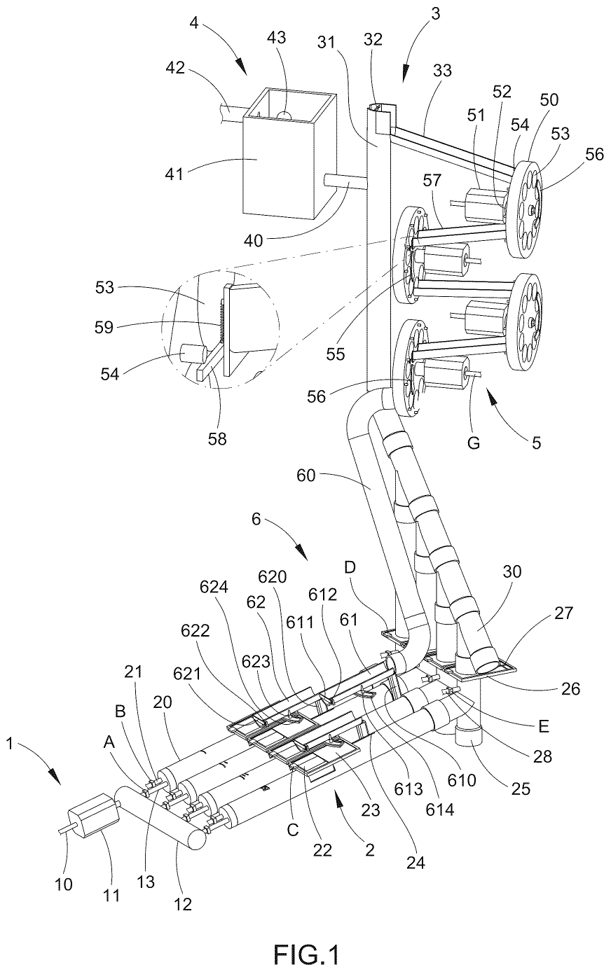

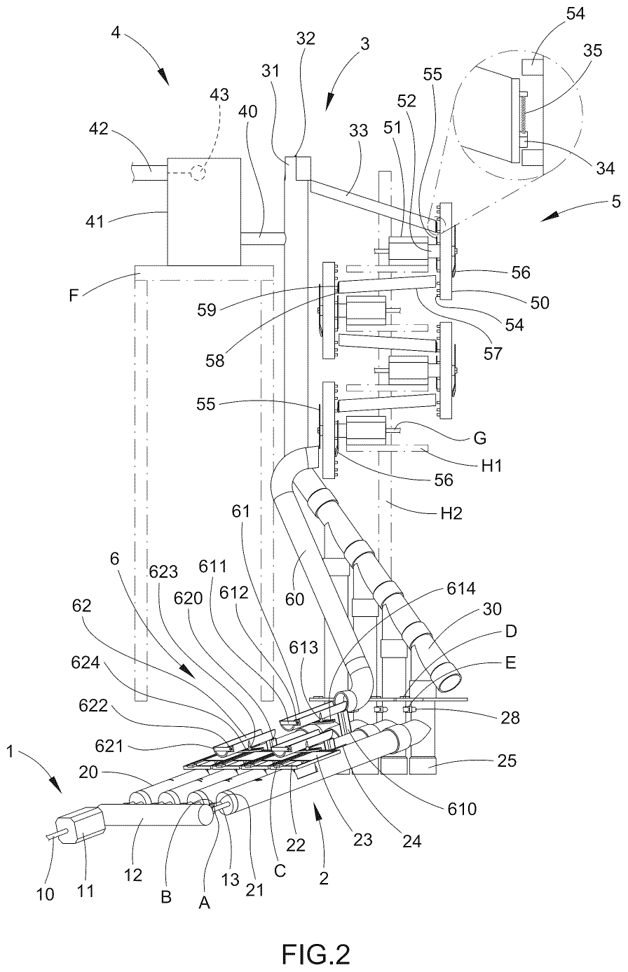

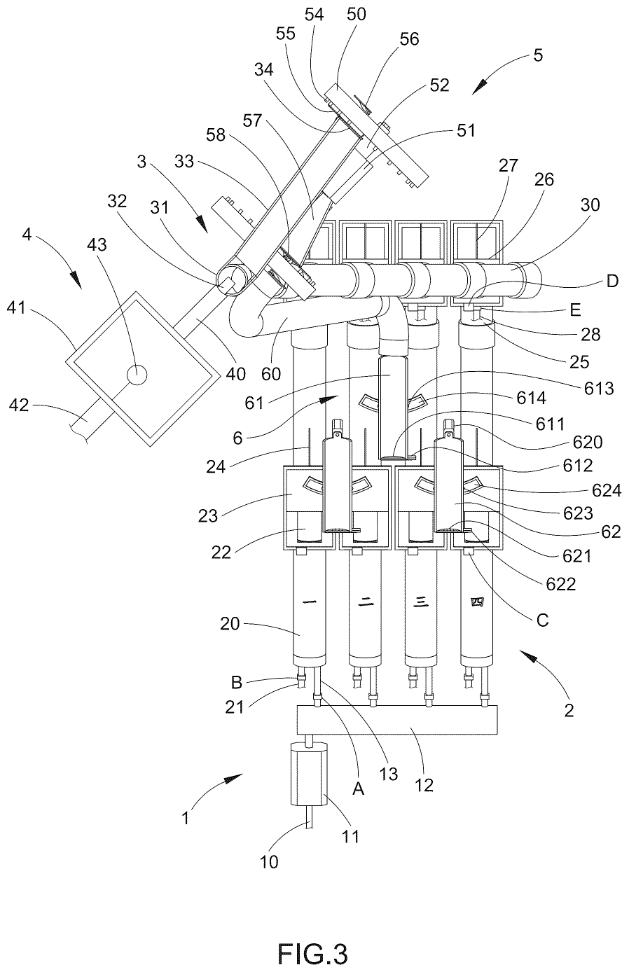

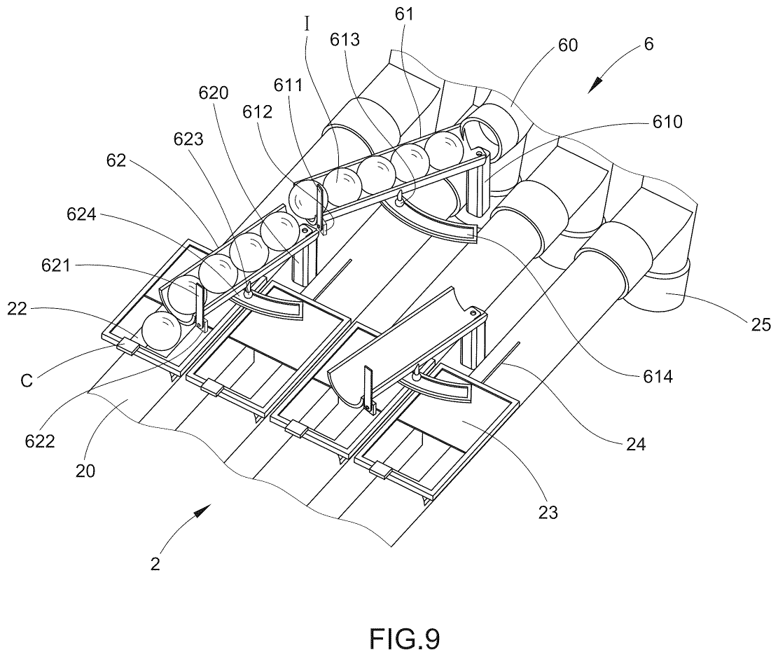

The embodiment of the present invention, referring to FIGS. 1 to 3, mainly includes a water collection unit 1, a ball collection unit 2, a ball transport unit 3, a water replenishment unit 4, a rotary wheel power generation unit 5, and a ball distribution unit 6, wherein the water collection unit 1 has a water pumping pipe 10 arranged thereon, a motor 11 connected with the water pumping pipe 10, a water collecting pipe 12 connected with the motor 11, a plurality of water inlet pipes 13 connected with the water collecting pipe 12, and a water inlet valve A installed on each of the water inlet pipes 13; wherein the ball collection unit 2 is connected with the water collection unit 1, wherein the ball collection unit 2 has a plurality of ball collecting pipes 20 connected with the water inlet pipes 13, a water outlet pipe 21 connected with each of the ball collecting pipes 20, a water outlet valve B provided on the water outlet pipe 21, a ball entry hole 22 and a ball gate controller C provided above the ball collecting pipes 20, a ball entry gate 23 provided at the ball entry hole 22, a ball gate pull rod 24 connected with the ball entry gate 23, a lower tee pipe 25 connected with each of the ball collecting pipes 20, a sluice controller D provided above the lower tee pipe 25, a sluice gate 26 provided by the lower tee pipe 25 penetration, a sluice pull rod 27 connected with the sluice gate 26, a discharge pipe 28 provided on the wall of the lower tee pipe 25, and a discharge valve E provided in the discharge pipe 28, wherein the ball collecting pipes 20 are in an inclined shape, and the ball collecting pipes 20 are allowed to be configured as the first to fourthly channels respectively, wherein the ball gate controller C controls the ball gate pull rod 24 to open or close the ball entry gate 23, wherein the bottom through hole of the lower tee pipe 25 is in a closed state, and the flow channel of the lower tee pipe 25 is a Y-shaped hole; wherein the ball transport unit 3 is connected with the ball collection unit 2, wherein the ball transport unit 3 has an upper tee pipe 30 connected with the lower tee pipe 25, a ball transport pipe 31 connected with the upper tee pipe 30, a guide bend corner 32 and a floating ball channel 33 provided at the top of the ball transport pipe 31, a floating baffle 34 provided in the floating ball channel 33, and a first elastic element 35 provided on the floating baffle 34 and fixed to the floating ball channel 33, wherein the upper tee pipe 30 is connected with the bottom through hole of the ball transport pipe 31 and is in a closed state, and the flow channel of the upper tee pipe 30 is a Y-shaped hole; wherein the water replenishment unit 4 is connected with the ball transport unit 3, wherein the water replenishment unit 4 has a water replenishment pipe 40 connected with the ball transport pipe 31, a water tank 41 connected with the water replenishment pipe 40 and arranged above the platform F, and a water supply pipe 42 and a floating switch 43 provided in the water tank 41; wherein the rotary wheel power generation unit 5 is connected with the ball transport unit 3, wherein the rotary wheel power generation unit 5 has a plurality of rotating wheels 50 and a plurality of generators 51 arranged thereon and the plurality of rotating wheels 50 and the plurality of generators 51 are allowed to be configured as the first group to the fourthly group respectively, a rotating shaft 52 provided on each of the generators 51 and connected with each of the rotating wheels 50, a plurality of floating ball holes 53 evenly provided through the entire circle of each of the rotating wheels 50 and corresponded to the floating ball channel 33 when rotating, a protrusion 54 provided on the inside of each of the rotating wheels 50 adjacent to each of the floating ball holes 53, a positioning baffle 55 provided on the inside or outside of each of the rotating wheels 50, an oblique baffle 56 provided on the inside or outside of each of the rotating wheels 50, (for example: the first to third groups are provided with the positioning baffles 55 on the inside of the rotating wheels 50, and are provided with the oblique baffles 56 on the outside of the rotating wheels 50; the fourth group of the rotating wheel 50 is provided with the oblique baffle 56 on the inside, and the positioning baffle 55 is provided on the outside of the rotating wheel 50) a ball transfer channel 57 provided between each of the rotating wheels 50 and corresponds with the floating ball hole 53, a ball transfer blocker 58 provided in the ball transfer channel 57, a second elastic element 59 provided on the ball transfer blocker 58 and fixed on the ball transfer channel 57, and a power cord G connected with each of the generators 51, wherein the generators 51 are installed on a bracket H1, the bracket H1 is fixed to a support column H2, the ball transfer channel 57 between each of the rotating wheels 50 is also capable of being fixed with the support column H2, and the bracket H1 has a support rod H3 arranged and connected with the positioning baffle 55 and the bevel baffle 56; wherein the ball distribution unit 6 is connected to the rotary wheel power generation unit 5, wherein the ball distribution unit 6 has a ball distribution tube 60, a main ball distribution channel 61 and two allocation ball channels 62 respectively arranged thereon, wherein the ball distribution tube 60 corresponds to the floating ball hole 53 of the rotating wheel 50, and the main ball distribution channel 61 corresponds to the ball distribution tube 60, and distributes the floating ball I to the two allocation ball channels 62 (referring to FIG. 9), wherein the first allocation ball channel 62 distributes the floating ball I to the ball entry hole 22 of the first ball collecting pipe 20 and the ball entry hole 22 of the second ball collecting pipe 20, wherein the second allocation ball channel 62 distributes the floating ball I to the ball entry hole 22 of the third ball collecting pipe 20 and the ball entry hole 22 of the fourth ball collecting pipes 20, wherein the main ball distribution channel 61 has a first swing element 610 disposed at one end thereof, a first ball distribution gate 611 and a first gate controller 612 disposed at the other end thereof, and a first roller 613 and an arc-shaped first track 614 provided at the bottom of the main ball distribution channel 61, wherein each of the two allocation ball channels 62 has a second swing element 620 disposed at one end thereof, a second ball distribution gate 621 and a second gate controller 622 disposed at the other end thereof, and a second roller 623 and an arc-shaped second track 624 provided at the bottom of each of the allocation ball channels. It is worth mentioning that the best implementation of the positioning baffle 55 and the oblique baffle 56 in the present invention is: the positioning baffle 55 provided on each of the rotating wheels 50 and the oblique baffle 56 provided on each of the rotating wheels 50 and on the opposite side of the positioning baffle 55. Furthermore, the positioning baffle 55 is arranged on the inside of each of the rotating wheels 50 of first few groups, the oblique baffle 56 is arranged on the outside of each of the rotating wheels 50 of first few groups, and the oblique baffle 56 is arranged on the inside of the rotating wheel 50 of the last group, the positioning baffle 55 is arranged on the outside of the rotating wheel 55 of the last group.

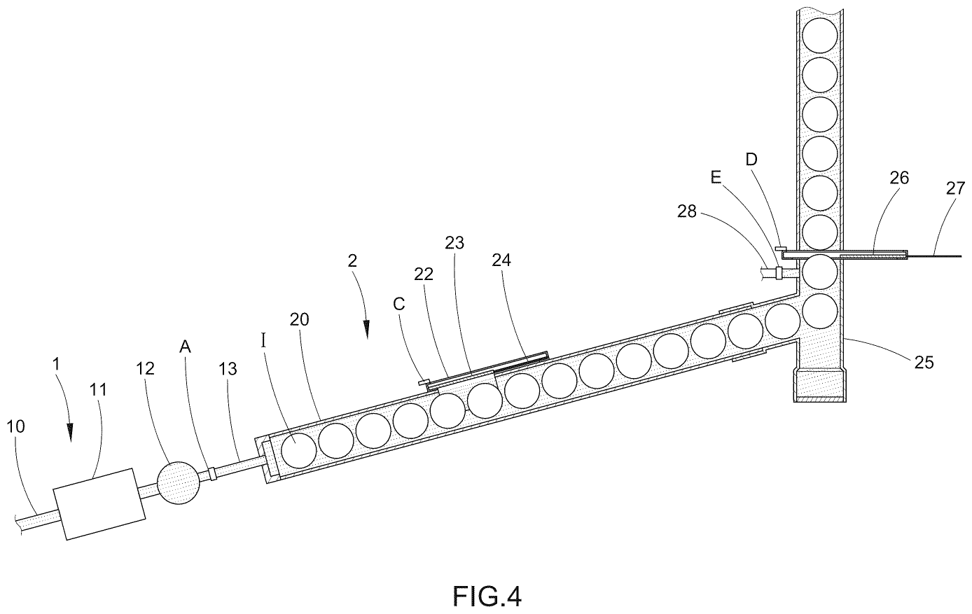

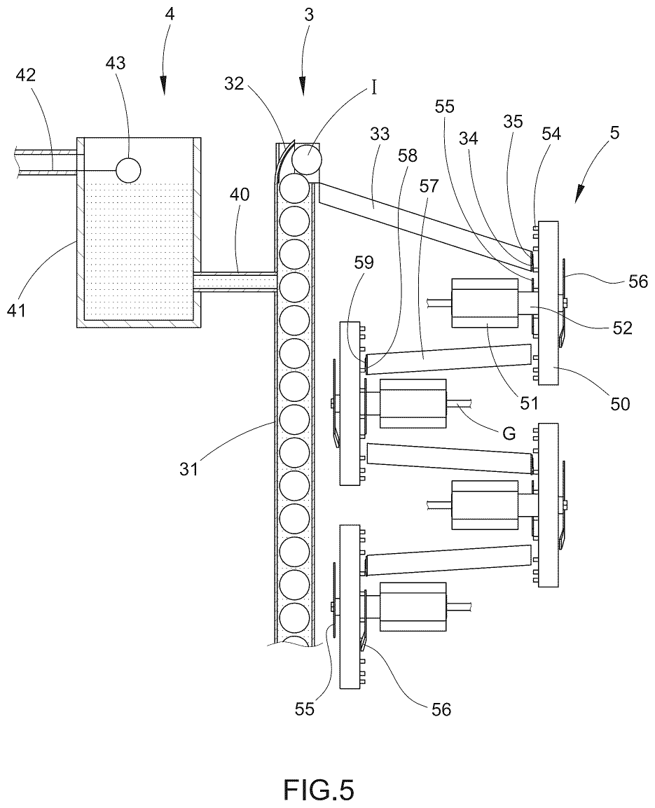

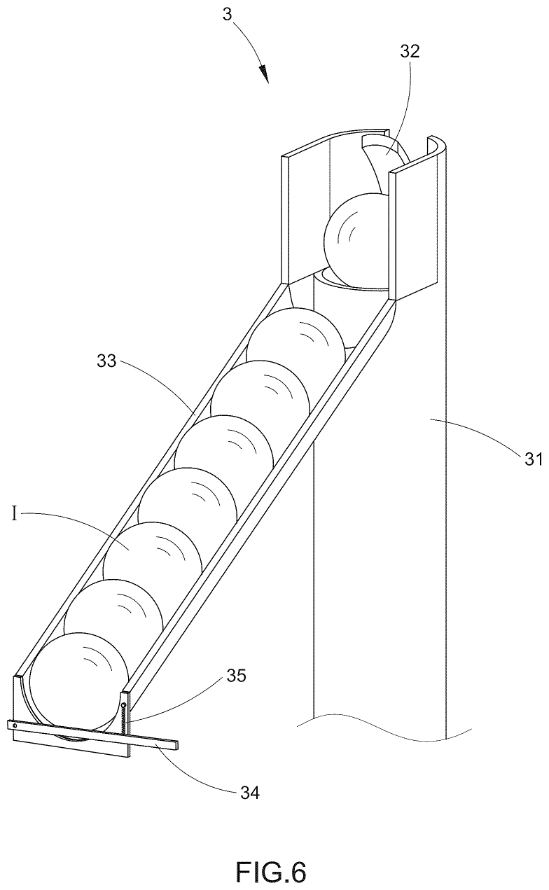

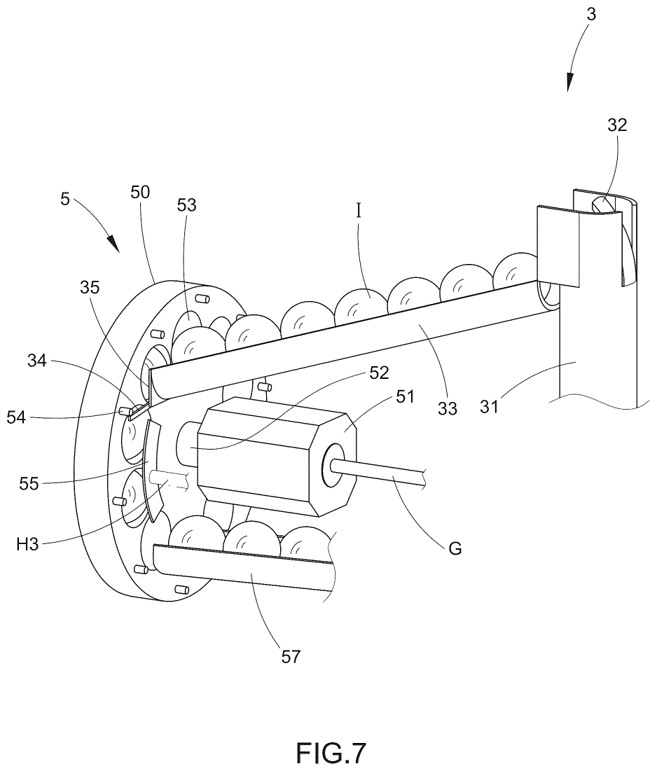

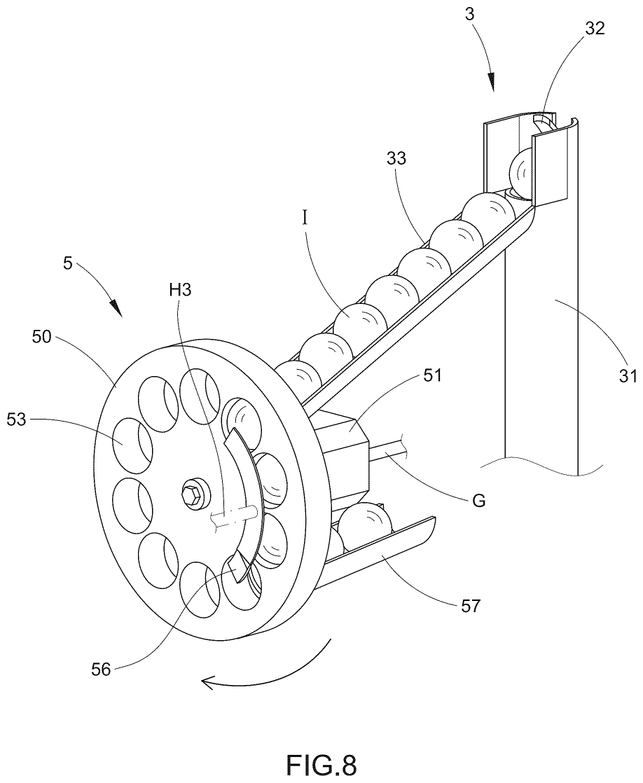

When the floating balls I drives the rotating wheels 50 to rotate and the rotating shafts 52 drives the generators 51 to generate electricity, referring to FIGS. 1 to 9. It is only necessary to turn on the motor 11, and the water pumping pipe 10 will supply water to the water collecting pipe 12, and then the water inlet valves A of the first to fourth channels are opened in sequence, and the water inlet pipes 13 of the first to fourth channels supply water to the ball collecting pipes 20 of the first to fourth channels in sequence, and the floating balls 1 have been prepared in the ball collecting pipes 20 of the first to the fourth channel at this moment. When the water flow fills the ball collecting pipe 20 of the first channel, the floating ball I will be driven by the water flow to the Y-shaped hole flow channel of the lower tee pipe 25 of the first channel. The discharge valve E of the first channel is initially opened and then closed after the water vapor is discharged from the discharge pipe 28. The sluice controller D of the first channel will control the sluice pull rod 27 to open the sluice gate 26, and the floating ball I will then be driven by the water flow to the Y-shaped hole flow channel of the upper tee pipe 30 of the first channel until the ball transport pipe 31, the sluice controller D of the first channel will then control the sluice pull rod 27 to close the sluice gate 26. When the water flow fills the ball collecting pipe 20 of the second channel, the floating ball I will be driven by the water flow to the Y-shaped hole flow channel of the lower tee pipe 25 of the second channel. The discharge valve E of the second channel is opened first and then closed after the water vapor is discharged from the discharge pipe 28. The sluice controller D of the second channel will control the sluice pull rod 27 to open the sluice gate 26, and the floating ball I will then be driven by the water flow to the Y-shaped hole flow channel of the upper tee pipe 30 of the second channel until the ball transport pipe 31, the sluice controller D of the second channel will then control the sluice pull rod 27 to close the sluice gate 26. When the water flow fills the ball collecting pipe 20 of the thirdly channel, the floating ball I will be driven by the water flow to the Y-shaped hole flow channel of the lower tee pipe 25 of the thirdly channel. The discharge valve E of the thirdly channel is opened first and then closed after the water vapor is discharged from the discharge pipe 28. The sluice controller D of the thirdly channel will control the sluice pull rod 27 to open the sluice gate 26, and the floating ball I will then be driven by the water flow to the Y-shaped hole flow channel of the upper tee pipe 30 of the thirdly channel until the ball transport pipe 31, the sluice controller D of the thirdly channel will then control the sluice pull rod 27 to close the sluice gate 26. When the water flow fills the ball collecting pipe 20 of the fourthly channel, the floating ball I will be driven by the water flow to the Y-shaped hole flow channel of the lower tee pipe 25 of the fourthly channel. The discharge valve E of the fourthly channel is opened first and then closed after the water vapor is discharged from the discharge pipe 28. The sluice controller D of the fourthly channel will control the sluice pull rod 27 to open the sluice gate 26, and the floating ball I will then be driven by the water flow to the Y-shaped hole flow channel of the upper tee pipe 30 of the fourthly channel until the ball transport pipe 31, the sluice controller D of the fourthly channel will then control the sluice pull rod 27 to close the sluice gate 26. The water tank 41 is supplied with water by the water supply pipe 42, and the floating switch 43 controls the amount of water in the water tank 41, and replenishes water to the ball transport pipe 31 through the water replenishment pipe 40 in a timely manner. The floating ball I in the ball transport pipe 31 is successively guided to the floating ball channel 33 from the guide bend corner 32 at the top. After rotating by the rotating wheel 50 of the first group, the floating baffle 34 is toggled by the protrusion 54, the first elastic element 35 stretches and opens the floating baffle 34, the floating ball I just rolls into the floating ball hole 53 of the rotating wheel 50, and is blocked by the positioning baffle 55 and the oblique baffle 56, and the first elastic element 35 immediately returns to close the floating baffle 34. After the rotating wheel 50 of the first group rotates, the floating baffle 34 is successively toggled by the protrusion 54, and then the floating ball I is sent into the floating ball hole 53 of the rotating wheel 50 one by one, driving the rotating wheel 50 to rotate clockwise. At the same time, the rotating shaft 52 drives the generator 51 of the first group to generate electricity until the oblique baffle 56 pushes the floating ball I in the floating ball hole 53, and the floating ball I just rolls into the ball transfer channel 57 to go to the second group. After rotating by the rotating wheel 50 of the second group, the ball transfer blocker 58 is toggled by the protrusion 54, the second elastic element 59 stretches and opens the ball transfer blocker 58, the floating ball I just rolls into the floating ball hole 53 of the rotating wheel 50, and is blocked by the positioning baffle 55 and the oblique baffle 56, and the second elastic element 59 immediately returns to close the ball transfer blocker 58. After the rotating wheel 50 of the second group rotates, the ball transfer blocker 58 is successively toggled by the protrusion 54, and then the floating ball I is sent into the floating ball hole 53 of the rotating wheel 50 one by one, driving the rotating wheel 50 to rotate clockwise. At the same time, the rotating shaft 52 drives the generator 51 of the second group to generate electricity until the oblique baffle 56 pushes the floating ball I in the floating ball hole 53, and the floating ball I just rolls into the ball transfer channel 57 to go to the thirdly group. After rotating by the rotating wheel 50 of the thirdly group, the ball transfer blocker 58 is toggled by the protrusion 54, the second elastic element 59 stretches and opens the ball transfer blocker 58, the floating ball I just rolls into the floating ball hole 53 of the rotating wheel 50, and is blocked by the positioning baffle 55 and the oblique baffle 56, and the second elastic element 59 immediately returns to close the ball transfer blocker 58. After the rotating wheel 50 of the thirdly group rotates, the ball transfer blocker 58 is successively toggled by the protrusion 54, and then the floating ball I is sent into the floating ball hole 53 of the rotating wheel 50 one by one, driving the rotating wheel 50 to rotate clockwise. At the same time, the rotating shaft 52 drives the generator 51 of the thirdly group to generate electricity until the oblique baffle 56 pushes the floating ball I in the floating ball hole 53, and the floating ball I just rolls into the ball transfer channel 57 to go to the fourthly group. After rotating by the rotating wheel 50 of the fourthly group, the ball transfer blocker 58 is toggled by the protrusion 54, the second elastic element 59 stretches and opens the ball transfer blocker 58, the floating ball I just rolls into the floating ball hole 53 of the rotating wheel 50, and is blocked by the positioning baffle 55 and the oblique baffle 56, and the second elastic element 59 immediately returns to close the ball transfer blocker 58. After the rotating wheel 50 of the fourthly group rotates, the ball transfer blocker 58 is successively toggled by the protrusion 54, and then the floating ball I is sent into the floating ball hole 53 of the rotating wheel 50 one by one, driving the rotating wheel 50 to rotate clockwise. At the same time, the rotating shaft 52 drives the generator 51 of the fourthly group to generate electricity until the oblique baffle 56 pushes the floating ball I in the floating ball hole 53, and the floating ball I just rolls into the ball distribution tube 60, and then rolls into the main ball distribution channel 61. The main ball distribution channel 61 is swung through the first swing element 610, the first roller 613 at the bottom of the main ball distribution channel 61 reciprocates along the first track 614, and the first gate controller 612 controls the first ball distribution gate 611 to open, and assigns the floating ball I to the first allocation ball channel 62 and the second allocation ball channel 62. Similarly, the first allocation ball channel 62 is swung through the second swing element 620, the second roller 623 at the bottom of the first allocation ball channel 62 reciprocates along the second track 624, and the second gate controller 622 controls the second ball distribution gate 621 to open, and assigns the floating ball I to the ball entry hole 22 of the ball collecting pipe 20 of the first channel and the ball entry hole 22 of the ball collecting pipe 20 of the second channel. Similarly, the second allocation ball channel 62 is swung through the second swing element 620, and the second roller 623 at the bottom of the second allocation ball channel 62 reciprocates along the second track 624. The second gate controller 622 controls the second ball distribution gate 621 to open, and assigns the floating ball I to the ball entry hole 22 of the ball collecting pipe 20 of the thirdly channel and the ball entry hole 22 of the ball collecting pipe 20 of the fourthly channel, and the ball gate controller C controls the ball gate pull rod 24 to open or close the ball entry gate 23, so that the floating ball I is prepared in the ball collecting pipe 20. In this way, the use of pipeline pumping water repeatedly transport the floating ball I to drive the rotation of the rotating wheels 50 and the transmission of the rotating shafts 52, so that the generators 51 can continue to generate electricity day and night, without being limited by weather factors and specific areas, and will not cause great pollution to the air and the environment, and do not have to import the coal or natural gas needed for power generation through the foreign countries, so as to achieve the floating ball I circulation drive, to provide a very sufficient amount of power generation.

In summary, the present invention has indeed achieved the expected objects and effects, and is more ideal and practical than those in the art. The above-mentioned embodiment is only specific descriptions for the preferred embodiments of the present invention, the embodiment is not intended to limit the scope of the patent application of the present invention, and all other equivalent changes and modifications accomplished without departing from the technical means disclosed in the present invention shall be covered by the present application.

What is claimed is:

1. A floating ball power generation system, comprising a water collection unit, a ball collection unit, a ball transport unit, a water replenishment unit, a rotary wheel power generation unit, and a ball distribution unit, wherein the water collection unit has a water pumping pipe arranged thereon, a motor connected with the water pumping pipe, a water collecting pipe connected with the motor, a plurality of water inlet pipes connected with the water collecting pipe, and a water inlet valve installed on each the water inlet pipe; wherein the ball collection unit is connected with the water collection unit, wherein the ball collection unit has a plurality of ball collecting pipes connected with the water inlet pipes, a water outlet pipe connected with each of the ball collecting pipes, a water outlet valve provided on the water outlet pipe, a ball entry hole and a ball gate controller provided above the ball collecting pipes, a ball entry gate provided at the ball entry hole, a ball gate pull rod connected with the ball entry gate, a lower tee pipe connected with each of the ball collecting pipes, a sluice controller provided above the lower tee pipe, a sluice gate provided by the lower tee pipe penetration, a sluice pull rod connected with the sluice gate, a discharge pipe provided on the wall of the lower tee pipe, and a discharge valve provided in the discharge pipe, wherein the ball gate controller controls the ball gate pull rod to open or close the ball entry gate; wherein the ball transport unit is connected with the ball collection unit, wherein the ball transport unit has an upper tee pipe connected with the lower tee pipe, a ball transport pipe connected with the upper tee pipe, a guide bend corner and a floating ball channel provided at the top of the ball transport pipe, a floating baffle provided in the floating ball channel, and a first elastic element provided on the floating baffle and fixed to the floating ball channel; wherein the water replenishment unit is connected with the ball transport unit, wherein the water replenishment unit has a water replenishment pipe connected with the ball transport pipe, a water tank connected with the water replenishment pipe, and a water supply pipe and a floating switch provided in the water tank; wherein the rotary wheel power generation unit is connected with the ball transport unit, wherein the rotary wheel power generation unit has a plurality of rotating wheels and a plurality of generators arranged thereon, a rotating shaft provided on each of the generators and connected with each of the rotating wheels, a plurality of floating ball holes evenly provided through the entire circle of each of the rotating wheels and corresponded with the floating ball channel when rotating, a protrusion provided on the inside of each of the rotating wheels adjacent to each of the floating ball holes, a positioning baffle provided on each of the rotating wheels, an oblique baffle provided on each of the rotating wheels and on the opposite side of the positioning baffle, a ball transfer channel provided between each of the rotating wheels and corresponds with the floating ball hole, a ball transfer blocker provided in the ball transfer channel, a second elastic element provided on the ball transfer blocker and fixed on the ball transfer channel, and a power cord connected with each of the generators; wherein the ball distribution unit is connected to the rotary wheel power generation unit, wherein the ball distribution unit has a ball distribution tube, a main ball distribution channel and two allocation ball channels respectively arranged thereon, wherein the ball distribution tube corresponds with the floating ball hole of the rotating wheel, and the main ball distribution channel corresponds with the ball distribution tube, and distributes the floating ball to the allocation ball channels, wherein the allocation ball channels distribute the floating ball to the ball entry holes of the ball collecting pipes.

2. The floating ball power generation system, as recited in claim 1, wherein the ball collection unit has the plurality of ball collecting pipes connected with the plurality of lower tee pipes, wherein the ball collecting pipes are in an inclined shape, and the ball collecting pipes are allowed to be configured as the first to fourthly channels respectively, wherein the plurality of lower tee pipes are connected with the plurality of upper tee pipes, and the ball transport pipe is connected with the plurality of upper tee pipes.

3. The floating ball power generation system, as recited in claim 1, wherein the bottom through hole of the lower tee pipe is in a closed state, and the flow channel of the lower tee pipe is a Y-shaped hole.

4. The floating ball power generation system, as recited in claim 1, wherein the bottom through hole of the upper tee pipe connected to the ball transport pipe is in a closed state, and the flow channel of the upper tee pipe is a Y-shaped hole.

5. The floating ball power generation system, as recited in claim 1, wherein the water tank is arranged above the platform.

6. The floating ball power generation system, as recited in claim 1, wherein the plurality of rotating wheels and the plurality of generators are allowed to be configured as the first group to the fourthly group respectively, wherein the ball transfer channel between each of the rotating wheels is fixed with the support column.

7. The floating ball power generation system, as recited in claim 1, wherein the generators are installed on a bracket, the bracket is fixed with a support column, and the bracket has a support rod arranged thereon and connected with the positioning baffle and the bevel baffle.

8. The floating ball power generation system, as recited in claim 1, wherein the main ball distribution channel has a first swing element disposed at one end thereof, a first ball distribution gate and a first gate controller disposed at the other end thereof, and a first roller and a first track provided at the bottom of the main ball distribution channel.

9. The floating ball power generation system, as recited in claim 1, wherein each of the two allocation ball channels has a second swing element disposed at one end thereof, a second ball distribution gate and a second gate controller disposed at the other end thereof, and a second roller and a second track provided at the bottom of each of the allocation ball channels.

10. The floating ball power generation system, as recited in claim 1, wherein the positioning baffle is arranged on the inside of each of the rotating wheels of first few groups, the oblique baffle is arranged on the outside of each of the rotating wheels of first few groups, and the oblique baffle is arranged on the inside of the rotating wheel of the last group, the positioning baffle is arranged on the outside of the rotating wheel of the last group.
